(19) United States
(12) Patent Application Publication
(10) Pub. No.: US 2012/0280432 A1
(43) Pub. Date: Nov. 8, 2012

(54) METHOD FOR MANUFACTURING BIOABSORBABLE STENTS

(75) Inventors: Jyh-Chern Chen, New Taipei City (TW); Kuo-Yao Weng, Hsinchu City (TW); Shian-Yih Wang, Taipei City (TW); Pin-Pin Wu, Taipei City (TW); Mei Lan Chen, Zhubei City (TW)

(73) Assignee: INDUSTRIAL TECHNOLOGY RESEARCH INSTITUTE, Hsinchu (TW)

(21) Appl. No.: 13/465,337

(22) Filed: May 7, 2012

Related U.S. Application Data
(60) Provisional application No. 61/483,447, filed on May 6, 2011.

(51) Int. Cl. B29C 49/50

(52) U.S. Cl. 264/400

(57) ABSTRACT

A method for manufacturing a bioabsorbable stent and an apparatus for doing the same are disclosed. The method includes providing a polymer resin, melting the polymer resin to form a molten hollow parison, cooling the molten hollow parison to form a hot hollow parison, elongating the hot hollow parison, expanding the hot hollow parison by feeding a compressed gas into the hot hollow parison to form a stent preform, and patterning the stent preform to form a bioabsorbable stent.

### CROSS REFERENCE TO RELATED APPLICATIONS

This application claims the benefit of U.S. Provisional Application No. 61/483,447, filed on May 6, 2011, the entirety of which is incorporated by reference herein.

### TECHNICAL FIELD

The technical field relates to a method for manufacturing a bioabsorbable stent, which is to be implanted in the blood vessel.

### BACKGROUND

Various medical situations require the use of an endoprosthesis to support a constricted vessel and maintain an open passageway through the vessel. Artery diseases such as atherosclerosis or myocardial infarction are usually treated with the percutaneous transluminal angioplasty (PTA) through the use of a balloon catheter. It involves passing a small, balloon-tipped catheter percutaneously into a vessel and up to the region of obstruction. The balloon is then inflated to dilate the area of obstruction. However, restenosis or reclosure of the dilated vessel are usually occurred due to the thrombosis following the angioplasty. A stent is a radially expandable endoprosthesis, which is adapted to be implanted in the bodily lumen, are used to prevent these situations.

Stents restrict restenosis or reclosure of blood vessels following the angioplasty by scaffolding intimal tissue flaps that have separated from deeper arterial layers, controlling early elastic recoil, optimizing vessel caliber, and preventing subsequent constrictive remodeling that were major limitations of angioplasty. Stents have also been implanted in urinary tracts and bile ducts and other bodily lumen. Delivery and implantation of a stent is accomplished by disposing the stent about a distal portion of the catheter, percutaneously inserting the distal portion of the catheter in a vessel, advancing the catheter in the lumen to a desired location, expanding the stent and removing the catheter from the lumen. In the case of a balloon expandable stent, the stent is mounted about a balloon disposed on the catheter and expanded by inflating the balloon. The balloon may then be deflated and the catheter withdrawn. In the case of a self-expanding stent, the stent may be held in place on the catheter via a retractable sheath. When the stent is in a desired bodily location, the sheath may be withdrawn allowing the stent to self-expand. The stent stays in the artery permanently, holds it open, and improves blood flow to the organ. Within a few weeks of the time the stent was placed, the inside lining of the artery (the endothelium) grows over the surface of the stent.

The development of bare metal stents (BMS) has been a major advance in the treatment of obstructive artery disease since the introduction of PTA. BMS is a mesh-like tube of thin wire usually made of 316L stainless steel or cobalt chromium alloy. However, metal is hydrophilic and tends to form the thrombus. Neointimal hyperplasia occurring within the BMS leading to in-stent restenosis is a main obstacle in the long-term success of PTA. The recent development of drug-eluting stents (DES) further contributes a major breakthrough to the interventional cardiology. DES is a metal stent placed into obstructive blood vessels that slowly releases a drug to block cell proliferation. The neointimal growth response to stenting that contributes to restenosis can be largely abolished by coating stents with antiproliferative drugs. DES has showed a remarkable reduction in in-stent restenosis and target vessel revascularization when compared with BMS. Despite the high success rate of DES, there is a low incidence of late stent thrombosis, which is probably because the antiproliferative drugs delay the growth of healthy endothelium over stent struts and their durable polymer coating. Furthermore, implanting a BMS or DES which will remain permanently in the human body, possess various long-term potential problems.

It has been a clinical consensus that the vessel scaffolding and drug delivery is only needed during the vascular healing period after stenting, and permanent scaffolding is needless after the cease of acute recoil and constrictive remodeling processes [Circulation 102 (2000) 371]. The recent introduction of the fully bioabsorbable stents that aim to fulfill these purposes will hold potential advantages. Unlike permanent BMS and DES, which are both afflicted with long-term risks, bioabsorbable stents that once dissolved will leave behind only the healed natural vessel, no need of eventual surgical removal, and late stent thrombosis will no longer be a concern. Further advantages of bioabsorbable stents over permanent stents include improved lesion imaging with computed tomography or magnetic resonance, facilitation of repeat surgical treatment to the same site, restoration of vasomotion, and freedom from side-branch obstruction by struts and from strut fracture-induced restenosis. Because bioabsorbable stents are less rigid than metal stents, they are more suitable for complex anatomy such as in superficial femoral and tibial arteries, where stent crush and fracture may occur due to flexion or extension articulations.

The development of bioabsorbable stents goes back to the mid-1980s, when pioneering work was done by Stack et al. [American J. Cardiovascular 62(1988)3F]. Since then, a number of international research groups have reported on various bioabsorbable stent designs, and some have gone through preclinical to clinical evaluation. Bioabsorbable stents are generally tubular and have been made of many materials, including bioabsorbable polymer, iron or magnesium based alloy. The polymer PLLA (poly-L-lactic acid) is used as a bioabsorbable coating of permanent metallic stents but can also be used to manufacture complete stents. The PLLA stents undergoes hydrolysis, resulting in lactic acid, and finally metabolism into carbon dioxide and water within 2-3 years after implantation. The bioabsorbable iron or magnesium based stents degrades within the body over a 2- to 3-month timeframe, forming inorganic salts containing calcium, chloride, oxide, sulfates and phosphates. The structure of bioabsorbable stents comprises pattern or network of interconnecting structural elements referred to as struts. A number of techniques have been suggested for the fabrication of stents from tubes, wires, or sheets of material rolled into a cylindrical shape.

Feasibilities of bioabsorbable stents have already been established. There are a number of requirements that must be satisfied by bioabsorbable stents, when they keep the blood vessel open for a specified period of time. Polymers tend to have lower strength than metals based on same mass basis. Therefore, polymeric stents typically have less circumferential strength and radial rigidity than metallic stents of the same or similar dimensions. Especially in the bending portions of the stent that are bent during crimping and expansion of the stent. As the structural element, the stent needs to possess sufficient radial strength to against radial compressive forces imposed on the stent. Once expanded, the stent must adequately maintain its size and shape throughout its service life, radial compressive forces tend to cause a stent to recoil inward. Generally, it is desirable to minimize recoil. Also, the stents should be sufficiently rigid to avoid stent deformity, despite the various forces that may come to bear on it, including the cyclic loading induced by the beating heart. In addition, the stents should have sufficient toughness or resistance to fracture from stress arising from crimping, expansion, and cyclic loading. Furthermore, the stent must possess sufficient flexibility to allow for crimping, expansion, and cyclic loading. Longitudinal flexibility is important to allow the stent to be maneuvered through a tortuous vascular path and to enable it to conform to a deployment site that may not be linear or may be subject to flexure.

It has been reported that the strength and rigidity of the polymer tube can be increased by expanding the tube wall radially and/or axially so as to orient the polymer molecules of the tube.

Above mentioned bioabsorbable stents are fabricated from expanded polymer tubes, which are made by reheating and expanding polymer tubes. However, polymer tubes that made from polymer resins or pellets must be processed by casting molding, injection molding, or extrusion molding in the first step of a two-stage process. The polymer tube is allowed to cool to the room temperature and is possible stored at temperature below −20° C. for later use in the case of PLLA. Polymer tubes are subsequently reheated and stretch blown through a second step of blow molding process into expanded polymer tubes. When PLLA resins are processed in elevated temperatures, PLLA resins are known to undergo thermal degradation, which can impact the mechanical properties of the resulting stents.

The thermal degradation of PLLA, which leads to the formation of lactide monomers, is related to the process temperature and the residence time in the extruder and hot mold. The rate of molecular weight loss of PLLA at 60° C. is more than 100 times greater than that PLLA at 40° C. [Progress in Polymer Science 2008(33) 820]. By and large, thermal degradation of PLLA resin can be attributed to: (a) hydrolysis by trace amounts of water, (b) zipper-like depolymerization, (c) oxidative, random main-chain scission by oxygen in air, (d) intermolecular transesterification to monomer and oligomeric esters, and (e) intramolecular transesterification resulting in formation of monomer and oligomer lactides of low molecular weight [Progress Material Sciences 2002(27)1123]. The moisture content of PLLA resin, temperature, and residence time of PLLA resin during the thermal processes are important contributors to molecular weight loss of PLLA [Apply Polymer Sciences 2001(79)2128]. These results highlighted the importance of minimizing the residence time and process temperature during the processing of PLLA resins. Furthermore, it is sometimes difficult to reheat the polymer tube uniformly to a suitable blowing temperature using a heater, which provides radiant energy to the outside of the polymer tube. A temperature gradient can exist from the outside wall to the inside wall of the polymer tube. It is possible to overheat the outside wall of the polymer tube when reheating the polymer tube to a suitable blowing temperature, which will affect the uniformity of wall thickness and mechanical properties of expanded polymer tubes after the blow-molding process.

### SUMMARY

One embodiment of the disclosure provides a method for manufacturing a bioabsorbable stent comprising providing a polymer resin; melting the polymer resin to form a molten hollow parison; cooling the molten hollow parison to form a hot hollow parison; elongating the hot hollow parison; expanding the hot hollow parison by feeding a compressed gas into the hot hollow parison to form a stent preform; and patterning the stent preform to form a bioabsorbable stent.

One embodiment of the disclosure provides a method for manufacturing a bioabsorbable stent comprising forming a molten hollow parison of a polymer resin from an annular die-head assembly; closing around the molten hollow parison by closing two halves of an opening tubular mold; shaping and partially cooling the molten hollow parison into a hot hollow parison; opening the tubular mold; closing around the hot hollow parison by closing two halves of an opening stretch-blowing mold; axially elongating the hot hollow parison by clamping one end of the hot hollow parison with a mandrel and moving inside the stretch-blowing mold; radially expanding the hot hollow parison by feeding a compressed gas into the hot hollow parison until the hot hollow parison conforms to an inside surface of the stretch-blowing mold to form an inflated hollow parison; cooling the inflated hollow parison to an ambient temperature to form a stent preform; releasing the stent preform from the stretch-blowing mold; and fabricating the stent preform into a bioabsorbable stent by impinging a specified pattern onto the stent preform with a pulsing laser cutting device.

One embodiment of the disclosure provides a method for manufacturing a bioabsorbable stent, comprising: forming a molten hollow parison of a programmed wall thickness of a polymer resin from an annular die-head assembly; closing around the molten hollow parison by closing two halves of an opening tubular mold; shaping and partially cooling the molten hollow parison of the programmed wall thickness into a hot hollow parison of a programmed wall thickness; opening the tubular mold; closing around the hot hollow parison of the programmed wall thickness by closing two halves of an opening stretch-blowing mold; axially elongating the hot hollow parison of the programmed wall thickness by clamping one end of the hot hollow parison of the programmed wall thickness with a mandrel and moving inside the stretch-blowing mold; radially expanding the hot hollow parison of the programmed wall thickness by feeding a compressed gas into the hot hollow parison of the programmed wall thickness until the hot hollow parison conforms to an inside surface of the stretch-blowing mold to form an inflated hollow parison of a programmed wall thickness; cooling the inflated hollow parison of the programmed wall thickness to an ambient temperature to form a stent preform of a programmed wall thickness; releasing the stent preform of the programmed wall thickness from the stretch-blowing mold; and fabricating the stent preform into a bioabsorbable stent by impinging a specified pattern onto the stent preform of the programmed wall thickness with a pulsing laser cutting device.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawing, wherein:

FIG. 1 is a schematic view of a flowchart and a processing temperature profile of a method for fabricating a stent preform from polymer resins according to an exemplary embodiment of the disclosure.

FIG. 2 depicts an exemplary stent.

FIGS. 3A-3C are schematic views of an embodiment depicting a perspective diagram of an annular die-head assembly and a tubular mold for making a hot hollow parison from a polymer resin in this disclosure.

FIGS. 4A-4G are schematic views of an embodiment depicting a perspective diagram of a stretch-blowing mold for making a stent preform from a hot hollow parison in this disclosure.

FIGS. 5A-5C are schematic views of an embodiment depicting a perspective diagram of an annular die-head assembly and a tubular mold for making a hot hollow parison of a variable wall thickness from a polymer resin in this disclosure.

FIGS. 6A-6G are schematic views of an embodiment depicting a perspective diagram of a stretch-blowing mold for making a stent preform of a variable wall thickness in this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It is also to be understood that the terminology used herein is for the purpose of describing particular embodiments, and is not intended to be limiting, as the scope of the present invention will be defined by the appended claims and equivalents thereof.

The singular forms “a,” “an,” and “the” include plural referents unless the context clearly dictates otherwise.

The term “coronary arteries” as used herein refers arteries that branch off the aorta to supply the heart muscle with oxygenated blood.

The term “endoprosthesis” as used herein refers to an artificial device that is placed inside the body of human or animal.

The term “lumen” as used herein refers to a cavity of a tubular organ such as a blood vessel, urinary tracts or bile ducts.

The term “hollow parison” as used herein refers to a hollow tubular polymeric mass before it is shaped into its final form. The term “molten hollow parison” as used herein refers to a hollow parison of molten polymer resin extruded from a die head assembly. The term “hot hollow parison” as used herein refers to a hollow parison partially cooled down to the stretch-blowing temperature of the polymer resin which made of it.

The term “peripheral arteries” as used herein refers to blood vessels outside the heart and brain.

The term “radial strength” as used herein refers the external pressure that a stent is able to withstand without incurring clinically significant damage. The necessary radial strength for most vascular applications is 0.8-1.2 bar [J. Chem. Technol. Biotechnol. 2010(85)744].

The term “resins” as used herein refers to designate any polymer that is a basic material for plastics.

The term “restenosis” as used herein refers to the reoccurrence of stenosis in a blood vessel or heart valve after it has been treated as by balloon angioplasty or valvuloplasty.

The term “stenosis” as used herein refers to a narrowing or constriction of the diameter of a bodily passage or orifice.

The term “stent preform” as used herein refers to a tubular material that has undergone preliminary engineering processes before being laser cutting or chemical etching into the stent structure.

The term “thermal degradation” as used herein refers to deterioration of the material by heat, characterized by molecular scission.

The term “stretch-blowing temperature” as used herein refers to the temperature at which a thermoplastic polymer is undergoing an expanding deformation. The stretch-blowing temperature of a thermoplastic polymer is usually in the range between the melting temperature and the glass transition temperature of the thermoplastic polymer.

The term “glass transition temperature” as used herein refers to the temperature at which a polymer changes from (or to) a viscous or rubbery condition (or from) a hard and relatively brittle one.

Currently, the most widely used bioabsorbable polymers have been polyglycolide (PGA), polylactide (PLA) and their copolymers. These bioabsorbable polymers are thermoplastic, linear, partially crystalline or totally amorphous polymers with a definitive melting temperature (Tm) and glass transition (Tg) region. PGA of high molecular weight is a hard, tough, crystalline polymer melting at about 224-228° C. with a Tg of 36° C. PLA is a pale polymer with a melting temperature at about 175-185° C., with a Tg of 55-57° C. Commercial PLA are copolymers of poly(1-lactic acid) (PLLA) and poly(d, 1-lactic acid) (PDLLA), while 1-isomer constitutes the main fraction. Depending on the composition of the 1- and d, 1-enantiomers, PLA polymer with higher 1-enantiomer content, tends to have higher melting temperature and higher glass transition temperature.

The materials used for bioabsorbable stents must provide certain essential safety-related mechanical properties, which include high initial strength, appropriate initial modulus and acceptable in vivo biodegradation rate. The high initial strength is required because the bioabsorbable stent must resist mechanical stresses during a surgical procedure and it must carry external and physiological loads during the healing stage of blood vessel. The appropriate modulus means that the bioabsorbable stent must not be too stiff and too flexible for the special purpose where it is used. The stent should possess ductile behavior so that it does not fracture with a brittle mechanism. The in vivo biodegradation rate of bioabsorbable polymer is essential for controlling the strength and modulus of bioabsorbable stent retaining in blood vessel. The loss of strength and modulus in vivo must be in coordinate with the healing of blood vessel. However, the mechanical properties of most bioabsorbable polymers are weak than the permanent metallic stent materials, such as stainless steel or cobalt-chromium alloy.

The mechanical properties of bioabsorbable polymers can be increased by reinforcing processes such as stretch molding, blow molding or stretch blow-molding. The polymeric articles made by the stretch blow-molding process give higher strength and modulus compared to those made by compress molding or injection molding process. The biaxial molecular orientation induced during the stretch blow-molding process will increase the strength and modulus of the resulting polymeric article. The polymeric articles made by the stretch blow-molding process is reinforced with oriented polymeric chains, fibrils, fibers, extended chain crystals and shish-kebab crystals, which have the same chemical composition as the polymer. In addition, the crystallites produced during strain-induced crystallization also reduce the aging effect since they can act as the physical crosslink to stabilize the amorphous phase, thereby reducing its brittleness.

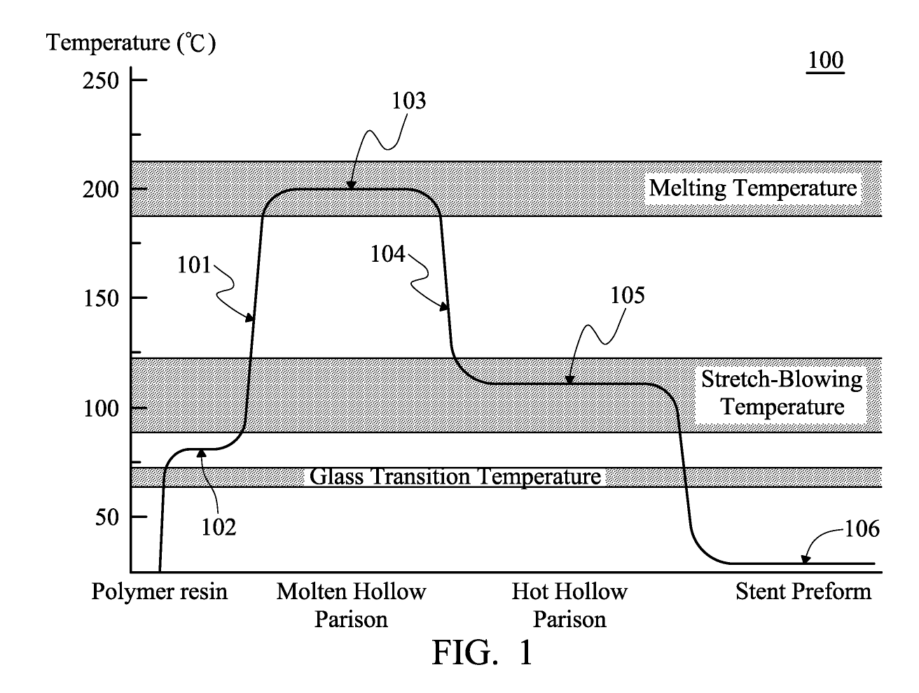

Embodiments of the disclosure relate to a method and an apparatus for manufacturing a bioabsorbable stent from a thermoplastic bioabsorbable polymer resin. In particular, the embodiments of the disclosure relates to a method and an apparatus for fabricating a stent preform from a polymer resin in one-stage process with reduced thermal exposure time to the polymer. A perspective flowchart of a method in this disclosure is depicted in FIG. 1. In step 1 102, a polymer resin is dried at a temperature which is 10-20° C. higher than its glass transition temperature to form a dehydrated polymer resin. In step 2 103, the dehydrated polymer resin is heated and melted at a temperature which is 10-20° C. higher than its melting temperature to form a molten polymer resin, then the molten polymer resin is formed into a molten hollow parison from an annular die-head assembly. In step 3 104, the molten hollow parison is shaped and partially cooled to a predetermined stretch-blowing temperature to form a hot hollow parison with a tubular mold. In step 4 105, the hot hollow parison is elongated by a mandrel and expanded by feeding a compressed gas thereinto until the hot hollow parison conforms to an inside surface of a stretch-blowing mold to form an inflated hollow parison, then the inflated hollow parison is cooled to an ambient temperature to form a stent preform. In step 5 106, the stent preform is used to fabricate a bioabsorbable stent by impinging a specified pattern onto the stent preform with a pulsing laser cutting means. During the fabrication of the stent preform, the polymer resin is exposed to a processing temperature profile 101, which is increased from an ambient temperature to a drying temperature and stays here for 4-6 hours, then it is quickly increased to a melting processing temperature, later it is quickly cooled down to a predetermined stretch-blowing temperature, which is in the middle range between a glass transition temperature and melting temperature of the polymer resin, finally, it is cooled down to the ambient temperature. Besides the drying time, the thermal exposure time for fabricating a stent preform from a polymer resin in this disclosure at temperature above its glass transition temperature is reduced when comparing it to the prior arts, which involves the formation of polymer tube in the first stage, and the additional reheating of the polymer tube in the second stage of a two-stage process.

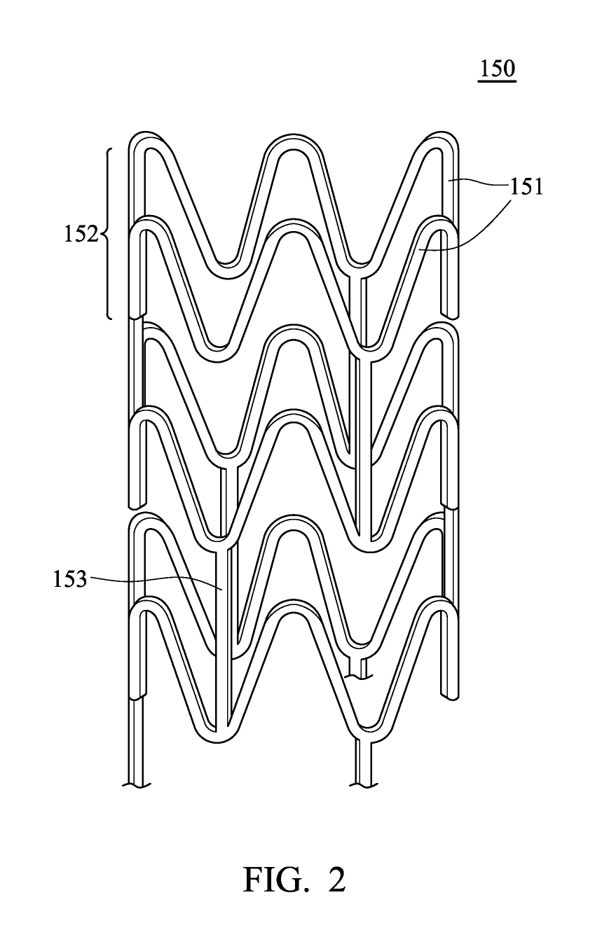

FIG. 2 depicts a view of an exemplary stent 150. The structural pattern in FIG. 2 is merely exemplary and serves to illustrate the basic structure and features of a stent pattern. In some embodiments, a stent 150 may include a body, backbone or scaffolding having a pattern or network, including interconnecting structural elements 151 and cylindrical rings 152 connected by linking elements 153. The cylindrical rings 152 are load-bearing in that they provide radially directed forces to support the walls of a vessel. The linking elements 153 generally function to hold the cylindrical rings 152 together. It is beneficiary to design the interconnecting structural elements 151, cylindrical rings 152 and linking elements 153 with variable thicknesses in order to provide better mechanical strength.

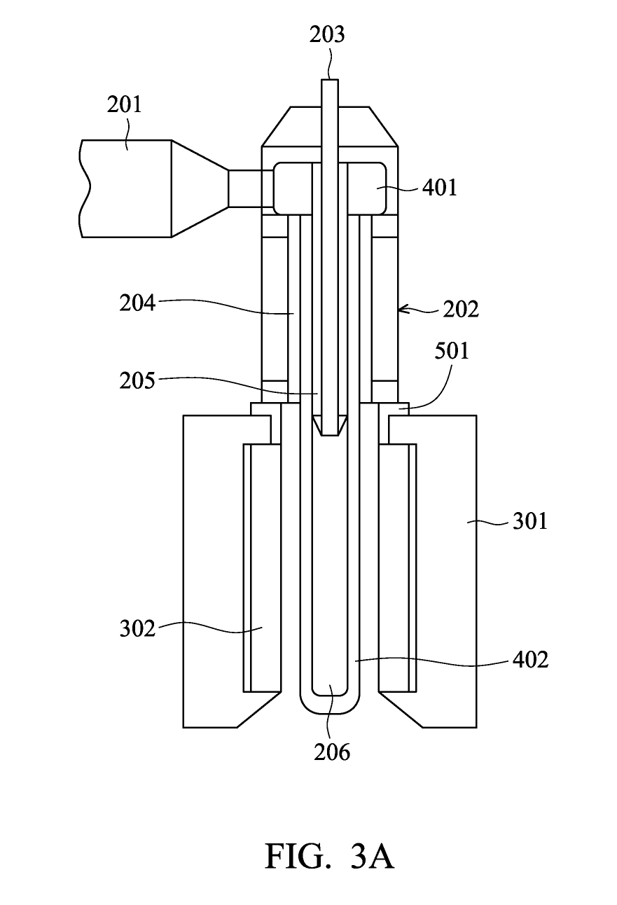

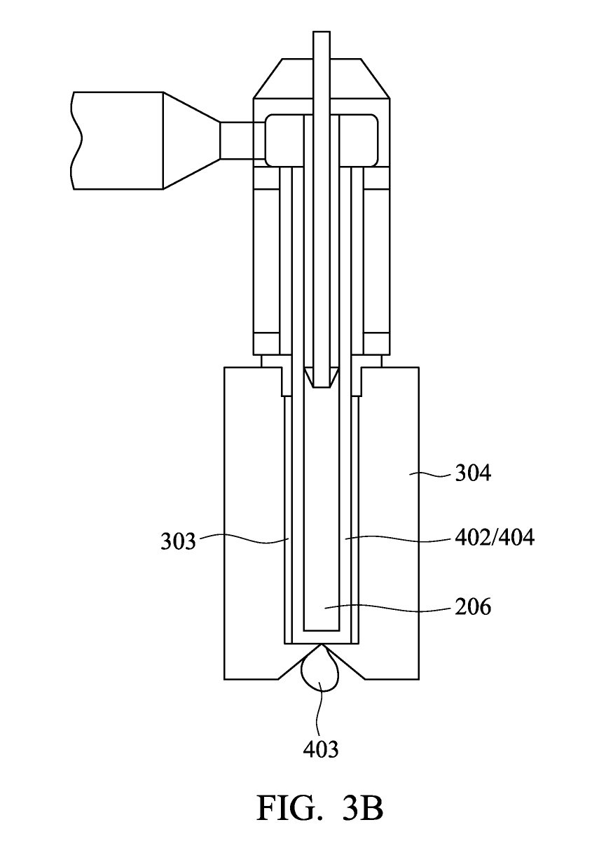

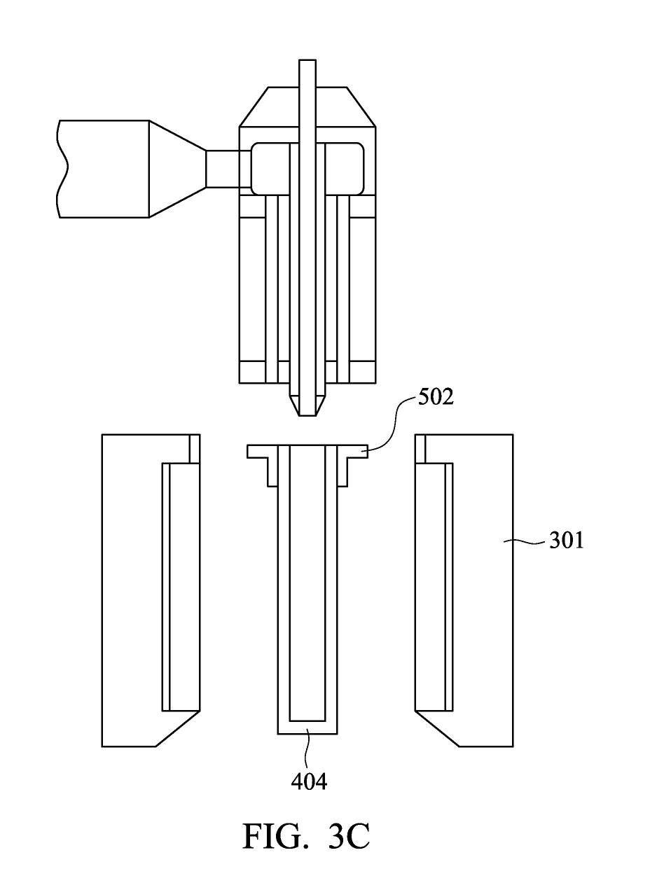

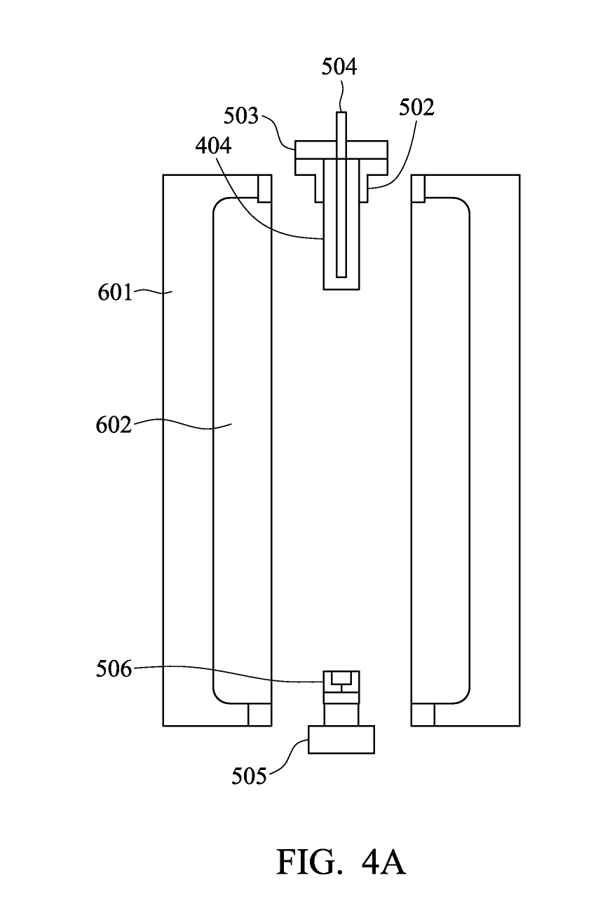

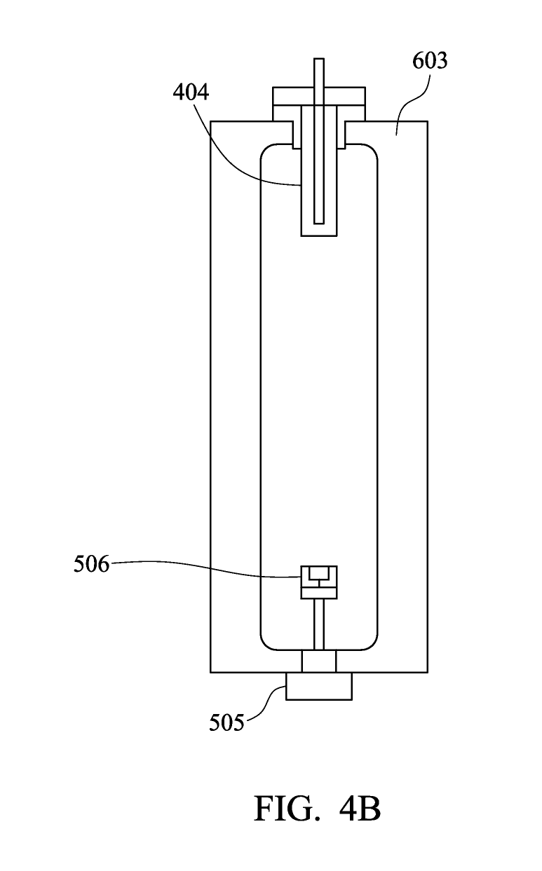

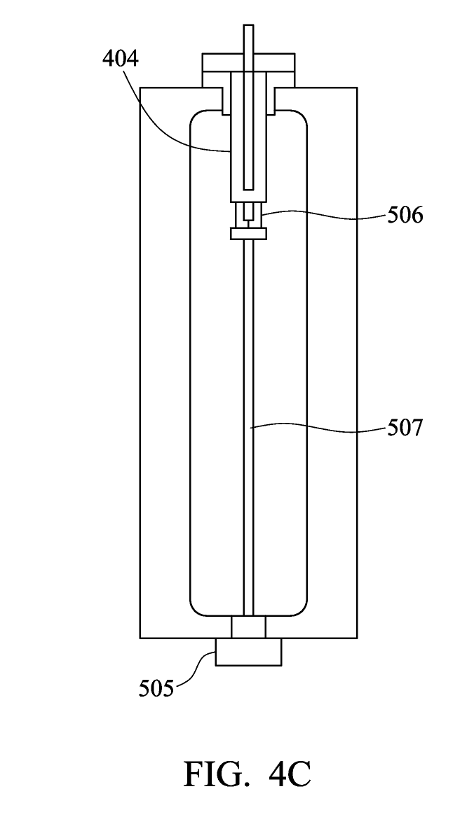

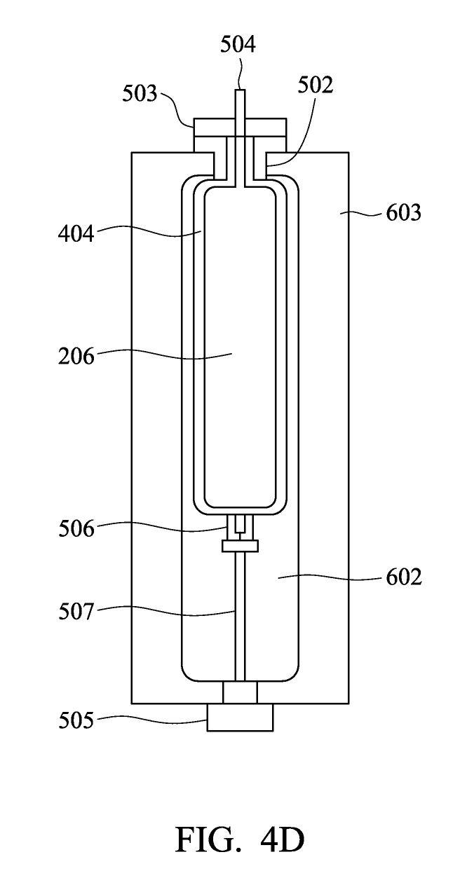

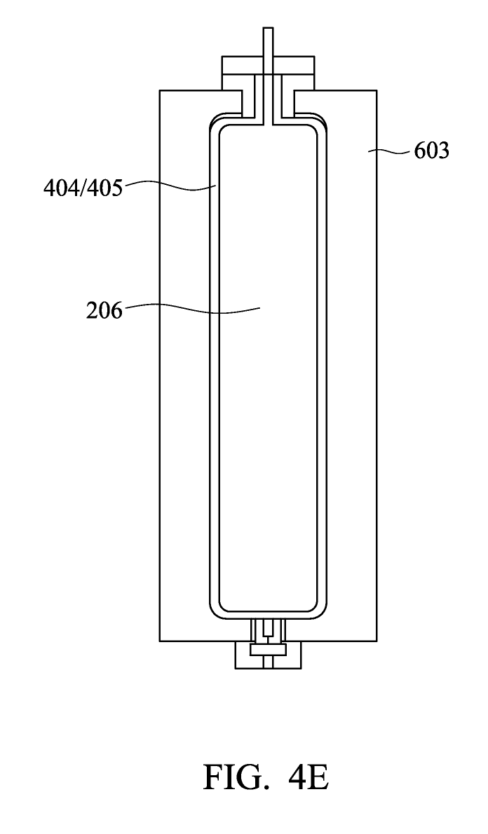

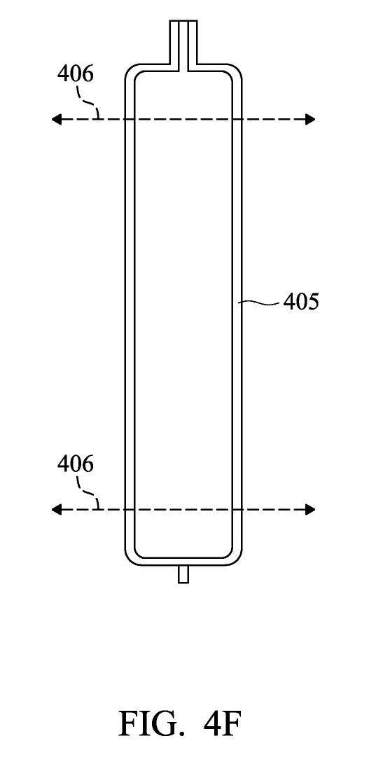

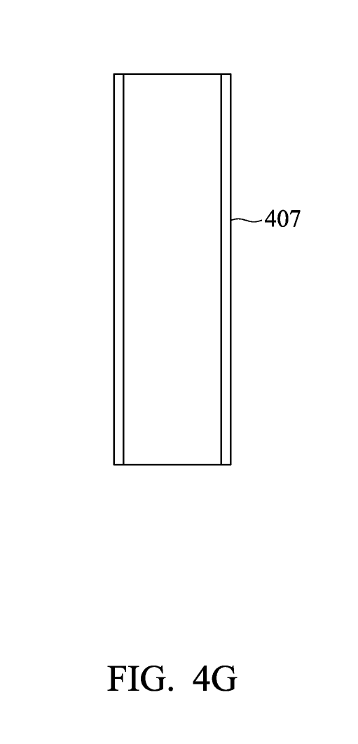

In one embodiment of this disclosure, a method and an apparatus for producing a bioabsorbable stent are depicted in FIGS. 3A-3C and 4A-4G. As depicted in FIG. 3A, a molten polymer resin 401 is heated and moved by an extruder 201 into an annual die-head assembly 202 that forms a molten hollow parison 402 around an annular region between an opening nozzle 204 and a first blow pin 205. The inside surface of the annual die-head assembly 202 is controlled at a melting temperature of the polymer resin. The molten hollow parison 402 is extruded vertically into an area between two halves of an opened tubular mold 301. A hot compressed air 206 (about 1.0 atm) is blown into the molten hollow parison 402 from a first compressed air inlet 203. The mass of the molten hollow parison 402 is controlled by the extruder 201. The diameters of the inside wall and the outside wall of the molten hollow parison 402 are controlled by the diameters of the inside wall of the opening nozzle 204 and the outside wall of the first blow pin 205. When the molten hollow parison 402 reaches a predetermined length, as depicted in FIG. 3B, the molten hollow parison 402 is closed around by two halves of a closed tubular mold 304, wherein the molten hollow parison 402 is shaped and partially cooled to form a hot hollow parison 404. The cavity formed by the closed tubular mold 304 has a uniform inside diameter of 0.25-3.00 mm and a length of 2.00-5.00 mm. The inside surface of the tubular mold 304 is controlled at a predetermined stretch-blowing temperature (a temperature in a range between a melting temperature and a glass transition temperature of the polymer resin) by a heater 303. The tubular mold 304 is made by high heat conductive materials such as metals. A pinch-off trim 403 is removed from the tubular mold 304. As depicted in FIG. 3C, the resulting hot hollow parison 404 is released by opening the two halves of the tubular mold 301, wherein the top portion of the hot hollow parison 404 is latched by a first damper 502. As depicted FIG. 4A, the resulting hot hollow parison 404 is released into an area between two halves of an opening stretch-blowing mold 601. The top portion of the hot hollow parison 404 is latched by the first damper 502 with a second compressed air inlet 504 and an air inlet holder 503. As depicted in FIG. 4B, the hot hollow parison 404 is positioned inside the cavity of a closed stretch-blowing mold 603, wherein a second damper 506 is driven by a motor 505 partially embedded inside the closed stretch-blowing mold 603. The tubular cavity formed by the closed stretch-blowing mold 603 has a uniform inside diameter of 1.50-5.00 mm and a length of 6.00-18.00 mm. The inside surface of the stretch-blowing mold 603 is controlled at a predetermined temperature in a range between an ambient temperature and 0° C. The stretch-blowing mold 603 is made by high heat conductive materials such as metals. As depicted in FIG. 4C, the bottom portion of the hot hollow parison 404 is clamped by the second damper 506 driven by an extendable mandrel 507 and the motor 505. As depicted in FIG. 4D, the hot hollow parison 404 is inflated by a hot compressed air 206 (about 1.0-5.0 atm) blown from the second compressed air inlet 504 into the hot hollow parison 404. Simultaneously, the hot hollow parison 404 is axially elongated by the second damper 506 driven by the extendable mandrel 507 and the motor 505. The inside surface of the stretch-blowing mold 603 is kept at the ambient temperature. As depicted in FIG. 4E, the hot hollow parison 404 is expanded in predetermined axially and radially expanding ratios to conform to the inside surface of the stretch-blowing mold 603 to form an inflated hollow parison 405. The inflated hollow parison 405 is cooled to a predetermined temperature about the room temperature. As depicted in FIGS. 4F and 4G, a stent preform 407 is made by laser-cutting 406 the top portion and bottom portion of the inflated hollow parison 405, which is released by opening the stretch-blowing mold 603. The stent preform 407 is then used to fabricating a bioabsorbable stent by impinging a specified pattern onto the stent preform 407 with a pulsing laser cutting means. In other embodiments, the hot hollow parison 404 may be further reheated to a predetermined temperature for the axially elongating and radially expanding to fabricate the stent preform or the inflated hollow parison.

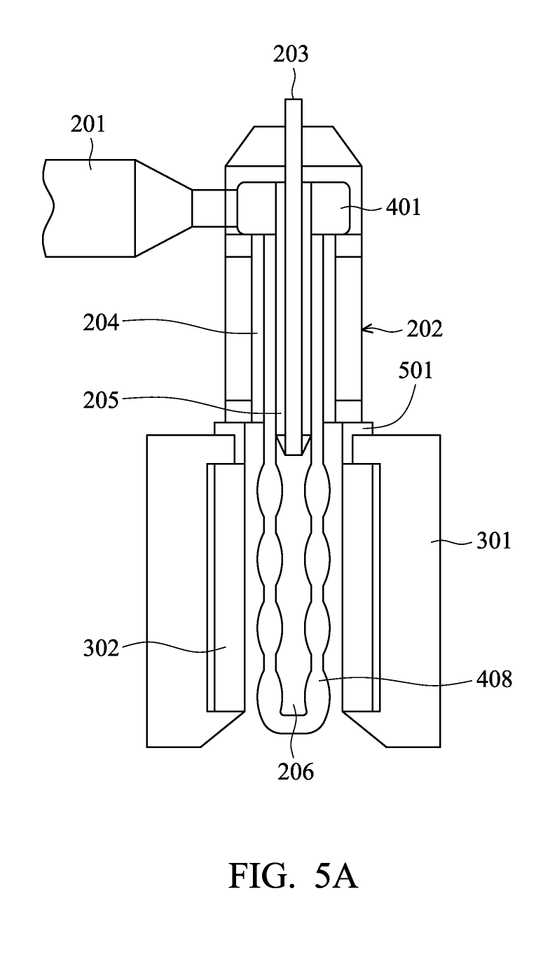

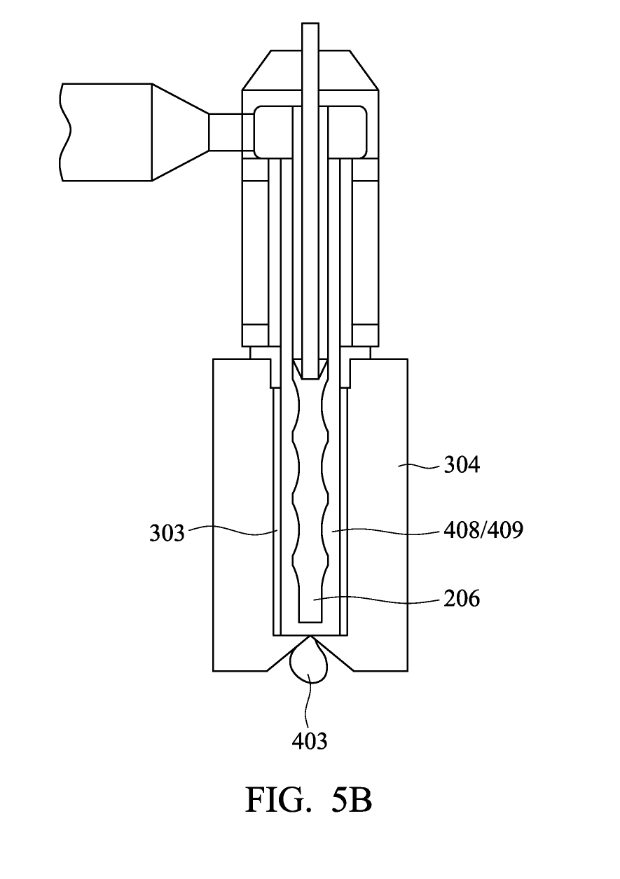

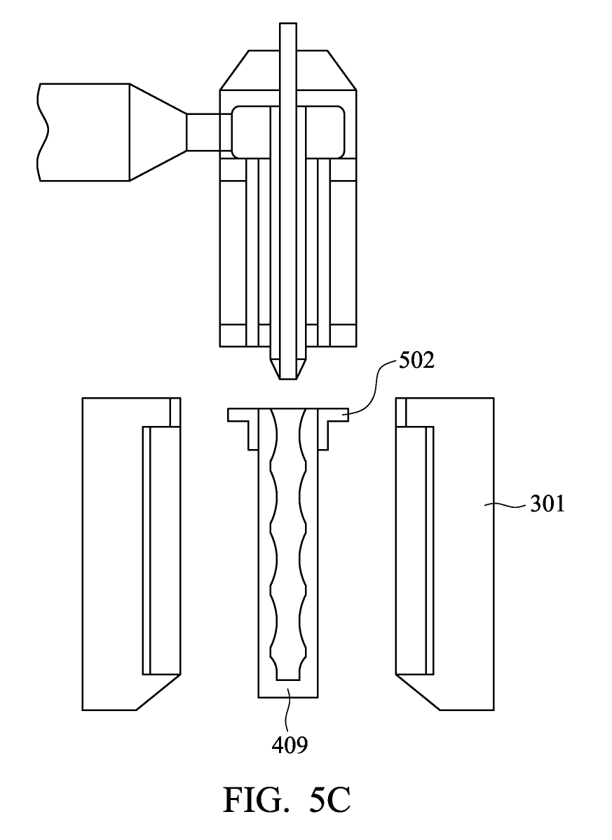

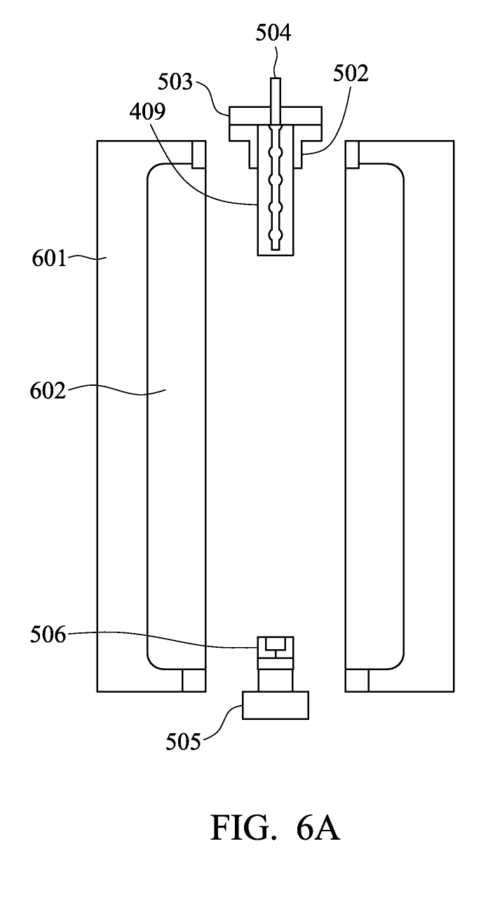

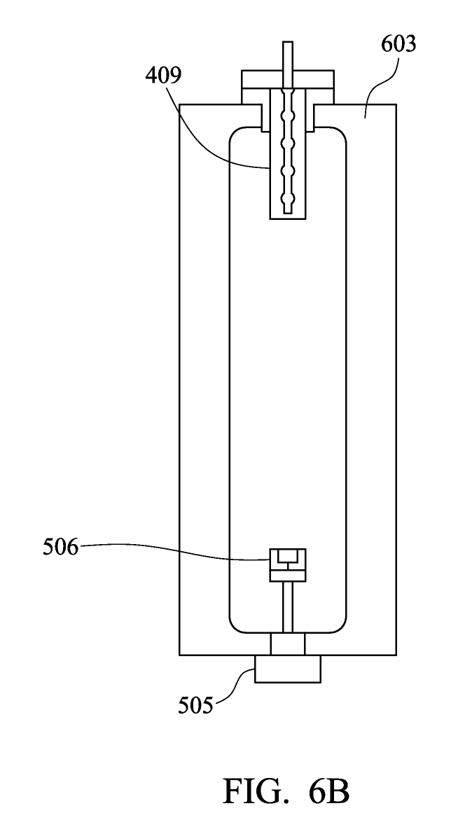

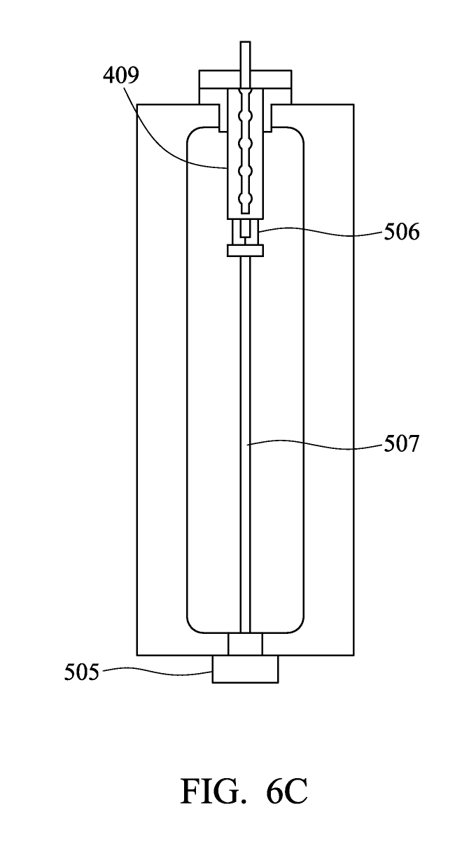

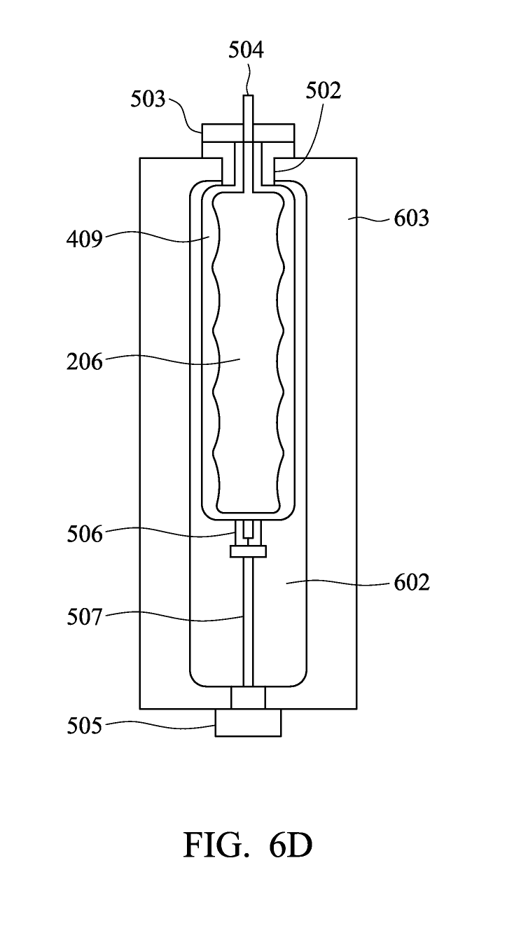

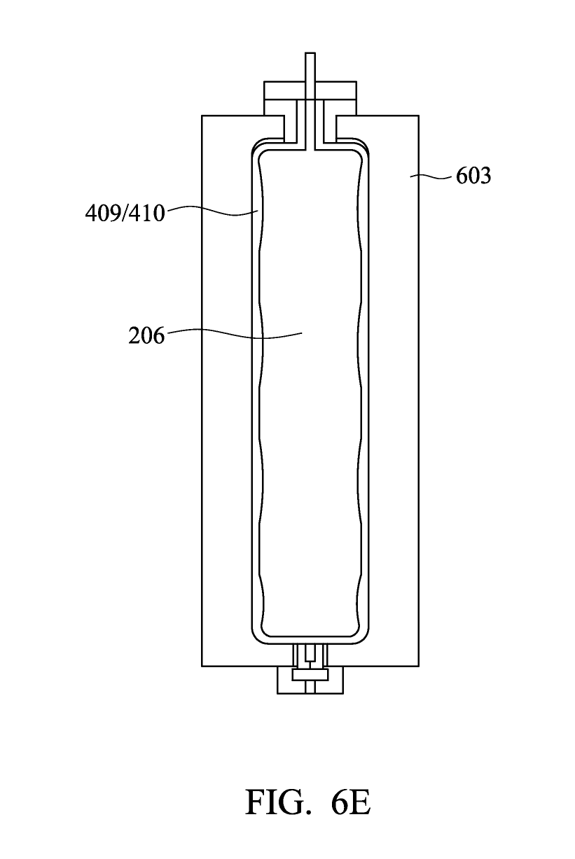

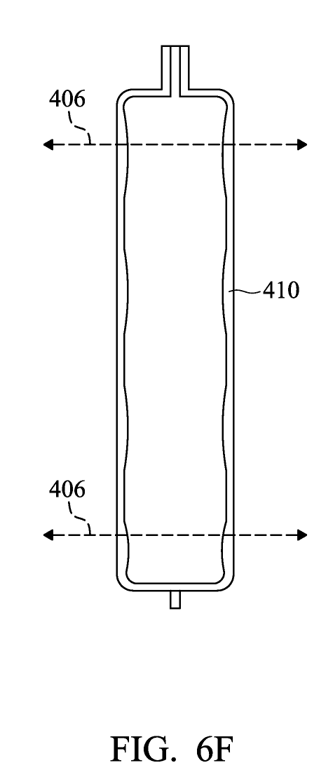

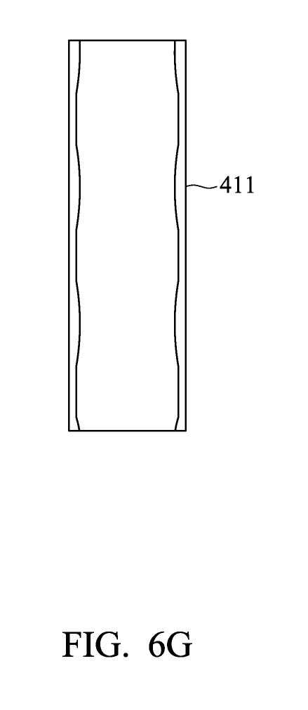

In another embodiment of this disclosure, a method and an apparatus for producing a bioabsorbable stent are depicted in FIGS. 5A-5C and 6A-6G. As depicted in FIG. 5A, a molten polymer resin 401 is heated and moved by an extruder 201 into an annual die-head assembly 202 that forms a molten hollow parison 408 of a programmed wall thickness around a variable annular region between an opening nozzle 204 and a first blow pin 205, wherein the inside diameter of the opening nozzle 204 is variably controlled. The inside surface of the annual die-head assembly 202 is controlled at a melting temperature of the polymer resin. The molten hollow parison 408 of the programmed wall thickness is extruded vertically into an area between two halves of an opened tubular mold 301. A hot compressed air 206 (about 1.0atm) is blown into the molten hollow parison 408 of the programmed wall thickness from a first compressed air inlet 203. The mass of the molten hollow parison 408 of the programmed wall thickness is controlled by the extruder 201. The diameters of the inside wall and the outside wall of the molten hollow parison 408 of the programmed wall thickness are controlled by the diameters of the inside wall of the opening nozzle 204 and the outside wall of the first blow pin 205. When the molten hollow parison 408 of the programmed wall thickness reaches a predetermined length, as depicted in FIG. 5B, the molten hollow parison 408 of the programmed wall thickness is closed around by two halves of a closed tubular mold 304, wherein the molten hollow parison 408 of the programmed wall thickness is shaped and partially cooled to form a hot hollow parison 409 of a programmed wall thickness. The cavity formed by the closed tubular mold 304 has a programmed variable inside diameter of 0.25-3.00 mm and a length of 2.00-5.00 mm. The inside surface of the tubular mold 304 is controlled at a predetermined stretch-blowing temperature (a temperature in a range between a melting temperature and a glass transition temperature of the polymer resin) by a heater 303. The tubular mold 304 is made by high heat conductive materials such as metals. A pinch-off trim 403 is removed from the tubular mold 304. As depicted in FIG. 5C, the resulting hot hollow parison 409 of the programmed wall thickness is released by opening the two halves of the tubular mold 301, wherein the top portion of the hot hollow parison 409 of the programmed wall thickness is latched by a first damper 502. As depicted FIG. 6A, the resulting hot hollow parison 409 of the programmed wall thickness is released into an area between two halves of an opening stretch-blowing mold 601. The top portion of the hot hollow parison 409 of the programmed wall thickness is latched by the first damper 502 with a second compressed air inlet 504 and an air inlet holder 503. As depicted in FIG. 6B, the hot hollow parison 409 of the programmed wall thickness is positioned inside the cavity of a closed stretch-blowing mold 603, wherein a second damper 506 is driven by a motor 505 partially embedded inside the closed stretch-blowing mold 603. The tubular cavity formed by the closed stretch-blowing mold 603 has a programmed variable inside diameter of 1.50-5.00 mm and a length of 6.00-18.00 mm. The inside surface of the stretch-blowing mold 603 is controlled at a predetermined temperature in a range between an ambient temperature and 0° C. The stretch-blowing mold 603 is made by high heat conductive materials such as metals. As depicted in FIG. 6C, the bottom portion of the hot hollow parison 409 of the programmed wall thickness is clamped by the second damper 506 driven by an extendable mandrel 507 and the motor 505. As depicted in FIG. 6D, the hot hollow parison 409 of the programmed wall thickness is inflated by a hot compressed air 206 (about 1.0-5.0atm) blown from the second compressed air inlet 504 into the hot hollow parison 409 of the programmed wall thickness. Simultaneously, the hot hollow parison 409 of the programmed wall thickness is axially elongated by the second damper 506 driven by the extendable mandrel 507 and the motor 505. The inside surface of the stretch-blowing mold 603 is kept at the ambient temperature. As depicted in FIG. 6E, the hot hollow parison 409 of the programmed wall thickness is expanded in predetermined axially and radially expanding ratios to conform to the inside surface of the stretch-blowing mold 603 to form an inflated hollow parison 410 of a programmed wall thickness. The inflated hollow parison 410 is cooled to a predetermined temperature about the room temperature. As depicted in FIGS. 6F and 6G, a stent preform 411 of a programmed wall thickness is made by laser-cutting 406 the top portion and bottom portion of the inflated hollow parison 410 of the programmed wall thickness, which is released by opening the stretch-blowing mold 603. The stent preform 411 of the programmed wall thickness is then used to fabricating a bioabsorbable stent by impinging a specified pattern onto the stent preform 411 of the programmed wall thickness with a pulsing laser cutting means. In other embodiments, the hot hollow parison 409 may be further reheated to a predetermined temperature for the axially elongating and radially expanding to fabricate the stent preform of the programmed wall thickness.

In contrast to the bioabsorbable stents that fabricate expanded polymer tubes by two-stage process in two separate apparatuses, the embodiments of the disclosure provides a cost-effective method for manufacturing bioabsorbable stents that fabricate expanded polymer tubes by one-stage process and one apparatus. In the two-stage process, polymer resins are first processed into polymer tubes by casting molding, injection molding, or extrusion molding processes in one apparatus, then, polymer tubes are reheated and expanded by blow-molding process in another apparatus. Because the overall exposure time of PLLA in elevated temperature during one-stage process is less than that of two-stage process, the thermal degradation of expanded PLLA tubes made from one-stage process are likely smaller than that of expanded PLLA tubes made from two-stage process. In addition, it is possible to overheat the outside wall of the polymer tube when reheating the polymer tube to a suitable blowing temperature in two-stage process. In one-stage process of the embodiments of the disclosure, an expanded polymer tube is fabricated from a hot parison by a blow-molding process. The hot parison is made from molten polymer resins by an extruder and is uniformly cooled down to a suitable blow-molding temperature. These results will affect mechanical properties of expanded PLLA tubes, which in turn, will influence mechanical properties of final bioabsorbable stents. The embodiments of the disclosure is to provide a method for manufacturing a bioabsorbable stent by fabricating an expanded polymer tube from polymer resins in one-stage process and an apparatus for doing the same.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for manufacturing a bioabsorbable stent, comprising:
forming a molten hollow parison of a polymer resin from an annular die-head assembly;
closing around the molten hollow parison by closing two halves of an opening tubular mold;
shaping and partially cooling the molten hollow parison into a hot hollow parison;
opening the tubular mold;
closing around the hot hollow parison by closing two halves of an opening stretch-blowing mold;
axially elongating the hot hollow parison by clamping one end of the hot hollow parison with a mandrel and moving inside the stretch-blowing mold;
radially expanding the hot hollow parison by feeding a compressed gas into the hot hollow parison until the hot hollow parison conforms to an inside surface of the stretch-blowing mold to form an inflated hollow parison;
cooling the inflated hollow parison to an ambient temperature to form a stent preform;
releasing the stent preform from the stretch-blowing mold; and
fabricating the stent preform into a bioabsorbable stent by impinging a specified pattern onto the stent preform with a pulsing laser cutting device.

2. The method for manufacturing a bioabsorbable stent as claimed in claim 1, further comprising reheating the hot hollow parison to a predetermined temperature for the axially elongating and radially expanding to fabricate the stent preform or the inflated hollow parison.

3. The method for manufacturing a bioabsorbable stent as claimed in claim 1, wherein the annular die-head assembly comprises an annular region surrounded by an opening nozzle having an axial center, and a first blow pin located in the axial center of the opening nozzle.

4. The method for manufacturing a bioabsorbable stent as claimed in claim 3, further comprising conveying a hot compressed gas into the molten hollow parison from the first blow pin, wherein the hot compressed gas has a pressure which is controlled at 1.0 atm.

5. The method for manufacturing a bioabsorbable stent as claimed in claim 3, wherein the molten hollow parison formed of the polymer resin is extruded from the annular region surrounded by the opening nozzle and the first blow pin.

6. The method for manufacturing a bioabsorbable stent as claimed in claim 3, wherein the molten hollow parison has a wall thickness which is controlled by diameters of an inside wall of the opening nozzle and an outside wall of the first blow pin.

7. The method for manufacturing a bioabsorbable stent as claimed in claim 1, wherein the annular die-head assembly has an inside temperature which is controlled at a melting temperature of the polymer resin.

8. The method for manufacturing a bioabsorbable stent as claimed in claim 1, wherein the tubular mold has an inside temperature which is controlled at a predetermined temperature in a range between a melting temperature and a glass transition temperature of the polymer resin.

9. The method for manufacturing a bioabsorbable stent as claimed in claim 1, wherein the tubular mold is closed to form a cavity which has a uniform inside diameter of 0.25-3.00 mm and a length of 2.00-5.00 mm.

10. The method for manufacturing a bioabsorbable stent as claimed in claim 1, wherein the tubular mold is made by high heat conductive materials.

11. The method for manufacturing a bioabsorbable stent as claimed in claim 1, wherein the stretch-blowing mold has an inside temperature which is controlled at a predetermined temperature in a range between an ambient temperature and 0° C.

12. The method for manufacturing a bioabsorbable stent as claimed in claim 1, wherein the stretch-blowing mold is closed to form a tubular cavity which has a uniform inside diameter of 1.50-5.00 mm and a length of 6.00-18.00 mm.

13. The method for manufacturing a bioabsorbable stent as claimed in claim 1, wherein the stretch-blowing mold is made by high heat conductive materials.

14. The method for manufacturing a bioabsorbable stent as claimed in claim 3, wherein the compressed gas is fed into the hot hollow parison from the first blow pin, wherein the compressed gas has a pressure which is controlled in a range between 1.0 atm and 5.0 atm.

15. A method for manufacturing a bioabsorbable stent, comprising:
forming a molten hollow parison of a programmed wall thickness of a polymer resin from an annular die-head assembly;
closing around the molten hollow parison by closing two halves of an opening tubular mold;
shaping and partially cooling the molten hollow parison of the programmed wall thickness into a hot hollow parison of a programmed wall thickness;
opening the tubular mold;
closing around the hot hollow parison of the programmed wall thickness by closing two halves of an opening stretch-blowing mold;
axially elongating the hot hollow parison of the programmed wall thickness by clamping one end of the hot hollow parison of the programmed wall thickness with a mandrel and moving inside the stretch-blowing mold;
radially expanding the hot hollow parison of the programmed wall thickness by feeding a compressed gas into the hot hollow parison of the programmed wall thickness until the hot hollow parison conforms to an inside surface of the stretch-blowing mold to form an inflated hollow parison of a programmed wall thickness;
cooling the inflated hollow parison of the programmed wall thickness to an ambient temperature to form a stent preform of a programmed wall thickness;
releasing the stent preform of the programmed wall thickness from the stretch-blowing mold; and
fabricating the stent preform into a bioabsorbable stent by impinging a specified pattern onto the stent preform of the programmed wall thickness with a pulsing laser cutting device.

16. The method for manufacturing a bioabsorbable stent as claimed in claim 15, further comprising reheating the hot hollow parison to a predetermined temperature for the axially elongating and radially expanding to fabricate the stent preform of the programmed wall thickness.

17. The method for manufacturing a bioabsorbable stent as claimed in claim 15, wherein the annular die-head assembly comprises an annular region surrounded by an opening nozzle having an axial center, and a first blow pin located in the axial center of the opening nozzle.

18. The method for manufacturing a bioabsorbable stent as claimed in claim 17, wherein the opening nozzle has an inside diameter which is variably

19. The method for manufacturing a bioabsorbable stent as claimed in claim 17, wherein the molten hollow parison of the programmed wall thickness formed of the polymer resin is extruded from the annular region surrounded by the opening nozzle and the first blow pin.

20. The method for manufacturing a bioabsorbable stent as claimed in claim 17, wherein the molten hollow parison has a wall thickness which is controlled by diameters of an inside wall of the opening nozzle and an outside wall of the first blow pin.

21. The method for manufacturing a bioabsorbable stent as claimed in claim 15, wherein the annular die-head assembly has an inside temperature which is controlled at a melting temperature of the polymer resin.

22. The method for manufacturing a bioabsorbable stent as claimed in claim 15, wherein the tubular mold has an inside temperature which is controlled at a predetermined temperature in a range between a melting temperature and a glass transition temperature of the polymer resin.

23. The method for manufacturing a bioabsorbable stent as claimed in claim 15, wherein the tubular mold is closed to form a cavity which has a programmed variable inside diameter of 0.25-3.00 mm and a length of 2.00-5.00 mm.

24. The method for manufacturing a bioabsorbable stent as claimed in claim 15, wherein the tubular mold is made by high heat conductive materials.

25. The method for manufacturing a bioabsorbable stent as claimed in claim 15, wherein the stretch-blowing mold has an inside temperature which is controlled at a predetermined temperature in a range between an ambient temperature and 0° C.

26. The method for manufacturing a bioabsorbable stent as claimed in claim 15, wherein the stretch-blowing mold is closed to form a tubular cavity which has a programmed variable inside diameter of 1.50-5.00 mm and a length of 6.00-18.00 mm.

27. The method for manufacturing a bioabsorbable stent as claimed in claim 15, wherein the stretch-blowing mold is made by high heat conductive materials.

28. The method for manufacturing a bioabsorbable stent as claimed in claim 17, wherein the compressed gas is fed into the hot hollow parison from the first blow pin, wherein the compressed gas has a pressure which is controlled in a range between 1.0 atm and 5.0 atm.

29. A method for manufacturing a bioabsorbable stent, comprising:
providing a polymer resin;
melting the polymer resin to form a molten hollow parison;
cooling the molten hollow parison to form a hot hollow parison;
elongating the hot hollow parison;
expanding the hot hollow parison by feeding a compressed gas into the hot hollow parison to form a stent preform; and
patterning the stent preform to form a bioabsorbable stent.
